(19) United States
(12) Patent Application Publication
(10) Pub. No.: US 2022/0358484 A1
(43) Pub. Date: Nov. 10, 2022

(54) System and Method for Dynamic Temporary Payment Authorization in a Portable Communication Device

(71) Applicant: Sequent Software, Inc., Santa Clara, CA (US)

(72) Inventors: David Brudnicki, Duvall, WA (US); Michael Craft, Carlsbad, CA (US); Hans Reisgies, San Jose, CA (US); Andrew Weinstein, San Francisco, CA (US); Miller Abel, Mercer Island, WA (US); Kaushik Roy, Foster City, CA (US)

(73) Assignee: Sequent Software, Inc., Santa Clara, CA (US)

(21) Appl. No.: 17/687,464

(22) Filed: Mar. 4, 2022

Related U.S. Application Data
(63) Continuation of application No. 14/052,640, filed on Oct. 11, 2013, now abandoned.
Application No. 14/052,640 is a continuation-in-part of application No. 13/448,193, filed on Apr. 16, 2012, now Pat. No. 9,898,728.
Application No. 14/052,640 is a continuation-in-part of application No. 13/448,193, filed on Apr. 16, 2012, now Pat. No. 9,898,728.
Application No. 14/052,640 is a continuation-in-part of application No. 13/448,193, filed on Apr. 16, 2012, now Pat. No. 9,898,728.
(60) Provisional application No. 61/577,652, filed on Dec. 19, 2011.
(60) Provisional application No. 61/577,652, filed on Dec. 19, 2011.
(60) Provisional application No. 61/577,652, filed on Dec. 19, 2011.

(51) Int. Cl. G06Q 20/32; G06Q 20/40; G06Q 20/38; G06Q 20/22; H04W 12/06; H04W 12/0471

(52) U.S. Cl. CPC G06Q 20/3224; G06Q 20/3274; G06Q 20/4012; G06Q 20/385; G06Q 20/3278; G06Q 20/227; H04W 12/068; H04W 12/0471

(57) ABSTRACT

A system for issuing a dynamic temporary credential to a portable communication device for use in a transaction with an electronic control point. The system receives the current geo-location of the portable communication device and transmits a dynamic temporary credential to the portable communication device from the centralized computer. The system further scores the risk in authorizing a transaction associated with an electronic control point using the dynamic temporary credential it issued. The system may prevent the transmission of the dynamic temporary credential until the end user has been authenticated, which may include verifying one or more of a manually input passcode, the unique digital signature of the portable communication device, and know your customer queries. The system may further include a validation mapping gateway operably connected to one or more issuers that substitutes legacy payment data for the dynamic temporary credential in a payment transaction before sending the payment transaction along with the risk score to the issuer associated with the legacy payment data.

### CROSS REFERENCE TO RELATED APPLICATIONS

This application is a continuation-in-part of U.S. non-provisional patent application Ser. No. 13/448,193, titled “System and Method for Dynamic Temporary Payment Authorization in a Portable Communication Device,” filed Apr. 16, 2012, which claims priority to U.S. Provisional Patent Application No. 61/577,652, titled “System and Method for One-Time Payments to a Retailer in a Portable Communication Device,” filed Dec. 19, 2011, the contents of each of which are incorporated herein by reference in their entireties.

### TECHNICAL FIELD

The present invention relates generally to the use of secure data to complete a wireless transaction, and more particularly to a system and method for processing a temporary electronic payment credential for use with a portable communication device.

### BACKGROUND

Wireless transactions using RFID-based proximity cards are fairly common place. For instance, many workers use RFID keycards to gain access to their workplace and drivers use RFID passes to pay tolls at highway speeds. RFID, which stands for radio-frequency identification, uses electromagnetic waves to exchange data between a terminal and some object for the purpose of identification. More recently, companies have been trying to use RFIDs supported by cellular telephones to implement an electronic payment product (i.e. credit and/or debit card). However, basic RFID technology raises a number of security concerns that have prompted modifications of the basic technology. Still, widespread adoption of RFID as a mechanism for electronic payments has been slow.

Smartphone penetration with consumers is also growing quickly. A challenge has arisen on how to enable consumers to make electronic payment using their existing mobile phone. Near Field Communication technology in phones with embedded secure elements enables one potential solution for this challenge.

Near Field Communication (NFC) is another technology that like RFID uses electromagnetic waves to exchange data. NFC is an open standard (see, e.g. ISO/IEC 18092) specifying modulation schemes, coding, transfer speeds and RF interface. Unlike RFID, NFC transmission and reception depend on electromagnetic coupling of the transmitter and receiver rather than RF propagation. NFC communication is thus possible only over a short-range (on the order of a few inches). There has been wider adoption of NFC as a communication platform because it is highly selective and therefore requires a deliberate physical gesture (e.g. waving the mobile device in front of the reader device) to enable communication. In this way, NFC provides better security for financial transactions and access control. Other short distance communication protocols are known and may gain acceptance for use in supporting financial transactions and access control.

NFC devices are already being used to make payments at some point of sale devices. But there are many mobile devices do not have the Secure Element hardware typically used to store contactless payment credentials securely. Accordingly, the present invention seeks to provide a solution to enable any smartphone to make highly secure electronic payments at merchants that accept contactless electronic payments with existing point-of-sale equipment.

Another problem is the myriad of credential types and communications protocols associated with the various different point of sale terminals available. So, for instance, one merchant may rely on barcode scanning while others may rely on contactless NFC or Bluetooth Low-Energy. And the radio protocol necessary to successfully communicate wirelessly with an IBM point of sale terminal may be very different from the radio protocol necessary to communication with an NCR terminal. Accordingly, some embodiments of the present invention seek to use geo-location data (where available) to try to predetermine the likely credential type, point of sale redemption method, terminal device type, and/or communication protocols present in the retail establishment co-located with the portable communication device.

The ability for physical merchants to accept electronic forms of payment has grown substantially in developed countries and is rapidly growing in developing countries. The financial industry has developed and deployed stringent systems, methods, and requirements on electronic transactions to mitigate and minimize fraudulent behavior.

Accordingly, the present invention also seeks to provide one or more solutions to the foregoing opportunities and related problems as would be understood by those of ordinary skill in the art having the present specification before them.

These and other objects and advantages of the present disclosure will also be apparent to those of ordinary skill in the art having the present drawings, specifications, and claims before them. It is intended that all such additional systems, methods, features, and advantages be included within this description, be within the scope of the disclosure, and be protected by the accompanying claims.

### BRIEF DESCRIPTION OF THE DRAWINGS

For a better understanding of the present disclosure, non-limiting and non-exhaustive embodiments are described in reference to the following drawings. In the drawings, like reference numerals refer to like parts through all the various figures unless otherwise specified.

FIG. 1A illustrates an end user attempting to use her portable communication device to conduct a secure payment transaction at a point of sale.

FIG. 1B illustrates the operable interconnections between the end user's smartphone (i.e. portable communication device) and various subsystems, including the system management back end.

FIG. 2 is a block diagram illustrating some of the logical blocks within a portable communication device that may be relevant to the present system.

FIGS. 3A and 3B together illustrate the flow in one potential embodiment of a process for one-time (i.e. temporary) payment credential.

FIG. 4 is a block diagram illustrating the information flow between a portable communication device and the remainder of the payment ecosystem in relation to the payment process illustrated in FIGS. 3A and 3B.

FIGS. 5, 6, and 6A are illustrations of an exemplary wallet user interface that may be deployed on a representative portable communication device.

FIGS. 7A, and 7B are illustrations of two potential embodiments of one-time payment credentials generated by an exemplary wallet user interface on a representative portable communication device.

FIG. 8A is a block diagram illustrating some of the logical blocks within a portable communication device that may be relevant to the present system;

FIG. 8B is a block diagram illustrating further detail of the “one-time payment wallet” block of FIG. 8A that may be relevant to the present system.

FIGS. 9A and 9B together illustrate one potential embodiment of a user interface that may be implemented on the illustrative smart phone further illustrating the flexibility of the one-time credential functionality coupled with a federated wallet.

FIGS. 9C and 9D illustrate another potential embodiment of a user interface that may be implemented on a portable communication device further illustrating the ability of an issuer to communicate directly with a user to obtain information that is often so sensitive (e.g. “Know your Customer” and CVV) entities prefer not to share the data.

FIG. 10 is a block diagram of one potential implementation of a system underlying the grant of permission for the one-time payment app to view, select and/or change secure data stored in the payment subsystem.

FIG. 11A is a block diagram illustrating the information flow between a portable communication device and the remainder of the payment ecosystem in relation to an embodiment of the temporary dynamic credential process illustrated in association with FIGS. 11B and 12.

FIG. 11B illustrates communication flow for obtaining a temporary credential token in one potential embodiment of a process.

FIG. 12 illustrates a payment communication flow using a temporary credential token in one potential embodiment of a process.

FIG. 13 illustrates an encryption mechanism that may be used in one potential embodiment of a process of obtaining and using a temporary electronic credential.

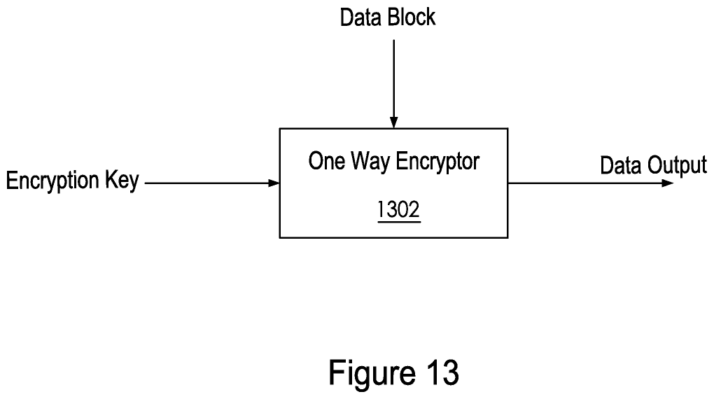

### DETAILED DESCRIPTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention and its components may take the form of an entirely hardware embodiment, an entirely software embodiment or an embodiment combining software and hardware aspects. The following detailed description is, therefore, not to be taken in a limiting sense.

### Portable Communication Devices

The present invention provides a system and method that can be utilized with a variety of different portable communication devices, including but not limited to PDA's, cellular phones, smart phones, laptops, tablet computers, and other mobile devices that preferably include cellular voice and data service as well as preferably access to consumer downloadable applications. One such portable communication device could be an iPhone, Motorola RAZR or DROID; however, the present invention is preferably platform and device independent. For example, the portable communication device technology platform may be Microsoft Windows Mobile, Microsoft Windows Phone 7, Palm OS, RIM Blackberry OS, Apple OS, Android OS, Symbian, Java or any other technology platform. For purposes of this disclosure, the present invention has been generally described in accordance with features and interfaces that are optimized for a smart phone utilizing a generalized platform, although one skilled in the art would understand that all such features and interfaces may also be used and adapted for any other platform and/or device. The portable communication device preferably includes one or more short proximity electromagnetic communication devices, such as an NFC, RFID, or Bluetooth transceiver. It is presently preferred to use an NFC baseband that is compliant with NFC IP 1 international standards (ISO/IEC 18092) and compliant to industry protocol standards such as those published by the NFC Forum (www.nfc-forum.org), which provide standard functions like peer-to-peer data exchange, reader-writer mode (i.e. harvesting of information from NFC tags), and contactless card emulation (per the NFC IP 1 and ISO/IEC 14443 standards) when paired with a secure element on the portable communication device and presented in front of a “contactless payment reader” (see below at point of sale). As would be understood in the art by those having the present specification, figures, and claims before them, the NFC IP 1 standards are simply the presently preferred example, which could be exported—in whole or in part—for use in association with any other proximity communication standard. It is further preferred that the portable communication device include an RFID antenna or an NFC antenna (conformed to NFC IP 1 and ISO 14443 standards and to other payment card industry standards such as those promulgated by EMV Co) to enable near field communications. However, as would be understood in the art, NFC as well as RFID communications may be accomplished using various non-conforming antennae and coil designs, over potentially even shorter ranges albeit with varying communication reliability and with other potential interoperability problems.

The portable communication device preferably includes one or more short proximity electromagnetic communication devices, such as an NFC, RFID, or Bluetooth transceiver. It is presently preferred to use an NFC baseband that is compliant with NFC IP 1 international standards (ISO/IEC 18092) and compliant to industry protocol standards such as those published by the NFC Forum (www.nfc-forum.org), which provide standard functions like peer-to-peer data exchange, reader-writer mode (i.e. harvesting of information from NFC tags), and contactless card emulation (per the NFC IP 1 and ISO/IEC 14443 standards) when paired with a secure element on the portable communication device and presented in front of a “contactless payment reader” (see below at point of sale). As would be understood in the art by those having the present specification, figures, and claims before them, the NFC IP 1 standards are simply the presently preferred example, which could be exported—in whole or in part—for use in association with any other proximity communication standard. It is further preferred that the portable communication device include an NFC/RFID antenna (conformed to NFC IP 1 and ISO 14443 standards and to other payment card industry standards such as those promulgated by EMV Co) to enable near field communications. However, as would be understood in the art, NFC/RFID communications may be accomplished using various non-conforming antennae and coil designs, over potentially even shorter ranges albeit with varying communication reliability and with other potential interoperability problems.

The portable communication device further preferably includes a location transceiver that can determine the physical coordinates of device on the surface of the Earth typically as a function of its latitude, longitude and altitude. This location transceiver preferably uses GPS technology, so it may be referred to herein as a GPS transceiver; however, it should be understood that the location transceiver can additionally (or alternatively) employ other geo-positioning mechanisms, including, but not limited to, triangulation, assisted GPS (AGPS), GLONASS, E-OTD, CI, SAI, ETA, BSS or the like, to determine the physical location of the portable communication device on the surface of the Earth. Altitude may be determined separately by other means or it may be part of the GPS function. And position and altitude may further be optimized by combination of various mechanisms. In selected embodiments, the location of the mobile device may be inferred or refined by the collection of network identities (e.g. detectable WiFi SSIDs, discoverable Bluetooth beacon IDs, access point MAC addresses).

The portable communication device further includes a user interface that provides some means for the consumer to receive information as well as to input information or otherwise respond to the received information. As is presently understood (without intending to limit the present disclosure thereto) this user interface may include a microphone, an audio speaker, a haptic interface, a graphical display, and a keypad, keyboard, pointing device and/or touch screen. The portable communication device will also include a microprocessor and mass memory. The mass memory may include ROM, Flash memory, RAM, non-volatile RAM, as well as one or more removable memory cards. The mass memory provides storage for computer readable instructions and other data, including a basic input/output system (“BIOS”) and an operating system for controlling the operation of the portable communication device.

The portable communication device will also include a device identification memory dedicated to identify the device, such as an electronic serial number (ESN), Mobile Equiment ID (MEID), International Mobile Equipment Identifier (IMEI). The portable communication device may also include a subscriber identity module, such as a SIM card or Universal Integrated Circuit Card (UICC) with a SIM application present and configured for network access. As is generally understood, SIM cards contain a unique serial number, identity of the issuing operator, an internationally unique number of the mobile user (IMSI), security authentication and ciphering information, temporary information related to the local network, a list of the services the user has access to and two passwords (PIN for usual use and PUK for unlocking). As would be understood in the art by those having the present specification, figures, and claims before them, other information may be maintained in the device identification memory depending upon the type of device, its primary network type, home mobile network operator, etc.

Portable communication devices may have two subsystems: (1) a “wireless subsystem” that enables communication and other data applications as has become commonplace with users of cellular telephones today, and (2) the “secure transactional subsystem” which may also be known as the “payment subsystem”. The secure transactional subsystem would include a secure element and associated device software for communication to management and provisioning systems as well as the customer facing interface for use and management of secure data stored in the secure element. It is contemplated that this secure transactional subsystem will preferably include a Secure Element, similar (if not identical) to that described as part of the Global Platform 2.1.X, 2.2, or 2.2.X (www.globalplatform.org). The secure element has been implemented as a specialized, separate physical memory used for industry common practice of storing payment card track data used with industry common point of sale; additionally, other secure credentials that can be stored in the secure element include employment badge credentials (enterprise access controls), hotel and other card-based access systems and transit credentials. Some portable communication devices may not have a secure transaction subsystem and particularly not have a secure element.

### Mobile Network Operator

Each of the portable communications devices is connected to at least one mobile network operator. The mobile network operator generally provides physical infrastructure that supports the wireless communication services, data applications and the secure transactional subsystem via a plurality of cell towers that communicate with a plurality of portable communication devices within each cell tower's associated cell. In turn, the cell towers may be in operable communication with the logical network of the mobile network operator, POTS, and the Internet to convey the communications and data within the mobile network operator's own logical network as well as to external networks including those of other mobile network operators. The mobile network operators generally provide support for one or more communication protocols and technologies including, but not limited to, global system for mobile communication (GSM), 3G, 4G, code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wide area or local area wireless communication protocols to communicate with the portable communication devices.

### Retail Subsystem

Standard at merchants today is an Internet Protocol connected payment system that allows for transaction processing of debit, credit, prepay and gift products of banks and merchant service providers. By swiping a magnetic stripe enabled card at the magnetic reader of a Point of Sale (or Point of Purchase) Terminal, the card data is transferred to the point of sale equipment and used to confirm funds by the issuing bank. This point of sale equipment has begun to include contactless card readers as accessories that allow for the payment card data to be presented over an RF interface, in lieu of the magnetic reader. The data is transferred to the reader through the RF interface by the ISO/IEC 14443 standard and proprietary payment applications like PayPass and Paywave, which transmit the contactless card data from a card or a mobile device that includes a Payment Subsystem.

A retailer's point of sale device 75 may be connected to a merchant payment network via a wireless or wired connection. This point of sale network may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, the point of sale network may utilize any communication method that allows information to travel between the point of sale devices and financial services providers for the purpose of validating, authorizing and ultimately capturing financial transactions at the point of sale for payment via the same financial services providers.

### System Management Back End

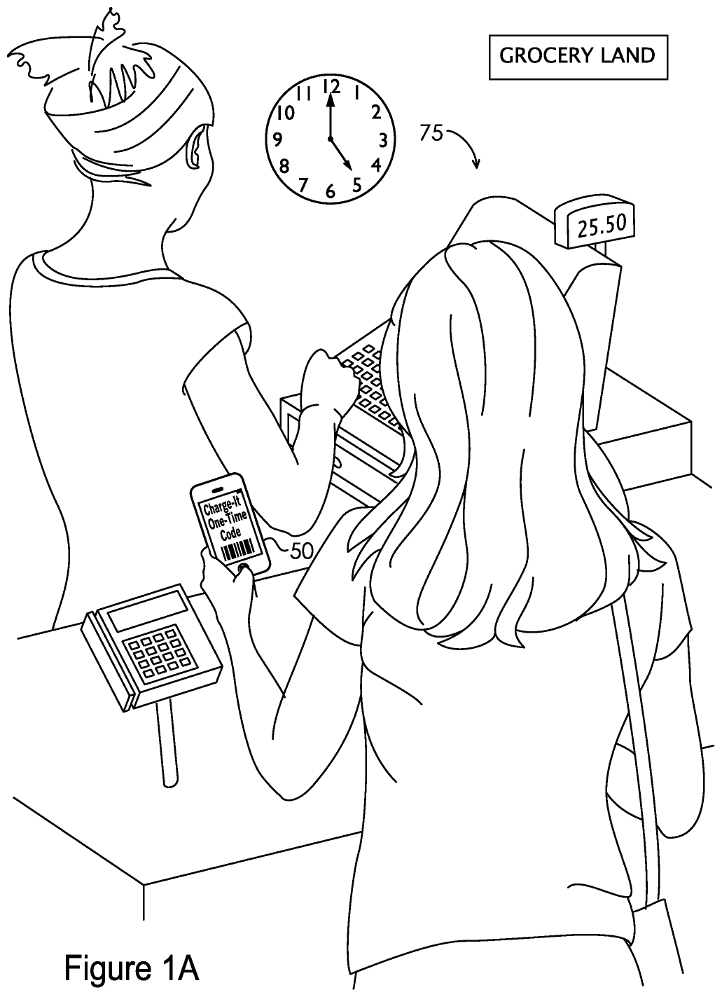

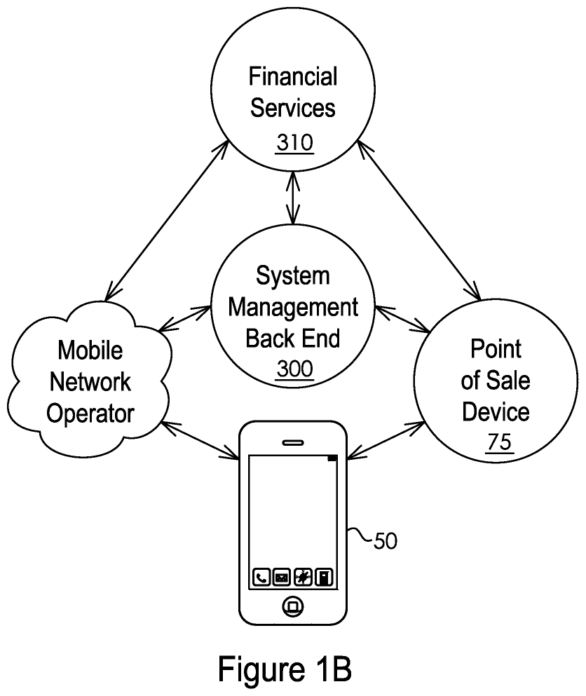

The system includes a system management back end. As shown in FIG. 1B, the system management back end 300 is connected to the retail subsystem (see point of sale device 75), the secure transactional subsystem (made up of one or more financial service providers) 310, and to a plurality of portable communication devices 50 via the infrastructure of at least one mobile network operator. The system management back end 300 comprises a server operably communicating with one or more client devices. The server is also in operable communication with the retailer subsystem 75, secure transactional subsystem 310, and one or more portable communication devices 50. Any type of voice channel may be used in association with the present invention, including but not limited to VoIP.

The server of the system management back end 300 may comprise one or more general-purpose computers that implement the procedures and functions needed to run the system back office in serial or in parallel on the same computer or across a local or wide area network distributed on a plurality of computers and may even be hosted by a third-party service provider on hardware connected via the Internet (a service hosting scheme known as “in the cloud”). The computer(s) comprising the server may be controlled by Linux, Windows®, Windows CE, Unix, or a Java® based operating system, to name a few widely used server technology platforms or it may be controlled by proprietary programming. The system management back end server is operably associated with mass memory that stores program code and data. Data may include one or more databases, text, spreadsheet, folder, file, or the like, that may be configured to maintain and store a knowledge base, user identifiers (ESN, IMSI, PIN, telephone number, email/IM address, billing information, or the like).

The system management back end server may support a case management system to provide call traffic connectivity and distribution across the client computers in the customer care center. In a preferred approach using VoIP voice channel connectivity, the case management system is a contact/case management system distributed by Contactual, Inc. of Redwood City, Calif. Any CRM system for use in providing VoIP-based customer care call center that also provides flexibility to handle care issues with simultaneous payments and cellular-related care concerns. As would be understood by one of ordinary skill in the art having the present specification, drawings and claims before them other case management systems may be utilized within the present invention such as Salesforce (Salesforce.com, inc. of San Francisco, Calif.) and Novo (Novo Solutions, Inc. of Virginia Beach, Va.).

The system management back end server also supports issuing engine 2010, user unique identification database 2011, merchant-geolocation collation database 2012, and predictive transaction module 2015. These elements will be described later in the specification.

Each client computer associated with the system management back end server has a network interface device, graphical user interface, and voice communication capabilities that match the voice channel(s) supported by the client care center server, such as VoIP. Each client computer can request status of both the cellular and secure transactional subsystems of a portable communication device. This status may include the contents of the soft memory and core performance of portable communication device, the NFC components: baseband, NFC antenna, secure element status and identification.

### Payment Subsystem

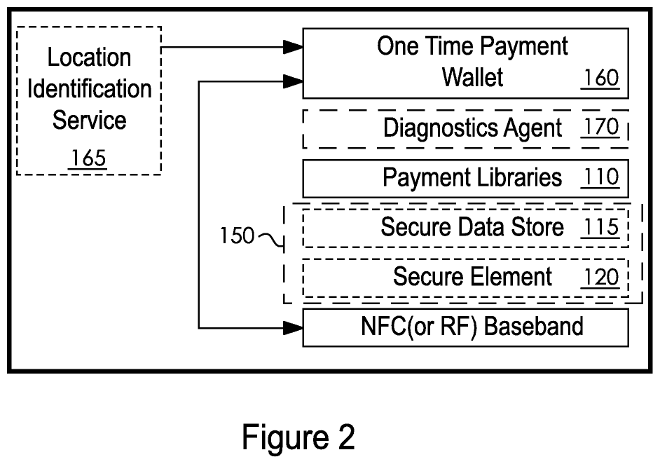

As shown in FIG. 2, each portable communication device 50 may contain one-time payment wallet 160, payment libraries 110, an NFC (or RF) Baseband, a payment subsystem 150 (i.e. secure data store 115 and secure element 120), and diagnostic agent 170. One-time payment wallet 160 is an application that enables any portable communication device to request and emulate credentials (e.g., card, coupon, access control and ticket data) in association with NFC/RF Baseband that are downloaded to the device 50 (preferably into payment subsystem 150) for temporary use. The application may also be implemented on legacy feature phones (non-smartphones) using WAP, J2ME RTE, and/or SMS channel in lieu of smartphone application. As will be discussed more fully herein below, the credentials are most preferably NFC based, but they may be transacted by means of RFID or Bluetooth transmission, or displayed as 2-D matrix codes, bar codes or Arabic numerals.

The payment libraries 110 are used by one-time payment wallet 160 to manage (and perform housekeeping tasks on) the secure element 120, interface with the system management back end 300, and perform over-the-air (OTA) provisioning via data communication transceiver (including its SMS channel), on the device 50. It is contemplated that the OTA data communications will be encrypted in some manner and an encryption key will be deployed in a card service module that is operably associated with the portable communication device 50 and with the payment subsystem 150. In one embodiment, card services module is operably coupled to one-time payment wallet 160 (deployed as a third party application as described below) and to the payment subsystem 150. Card services module generally enforces access control to the data stored in the payment subsystem 150 and controls the function(s) each application is allowed to conduct with the payment subsystem 150. In one embodiment, card services module verifies the author/issuer of each third party application in use on the portable communications device to access the payment subsystem (as generally described below). The payment subsystem 150 may be used to store credentials such as the temporary one-time payment card in addition to other payment card(s), coupon, access control and ticket data (e.g., transportation ticket data, concert ticket data, etc.). Some of these credential types may be added to the payment subsystem and payment libraries depending upon circumstances.

Where included, the secure data store 115 would provide secured storage on the portable communication device 50. Various levels of security may be provided depending upon the nature of the data intended for storage in secure data store 115. For instance, secure data store 115 may simply be password-protected at the operating system level of device 50. As is known in these operating systems, the password may be a simple alphanumeric code or a hexadecimal representation of a binary code that is stored somewhere on the device 50. Alternatively, the data in secure data store 115 is preferably encrypted. More likely, however, the secure data store 115 will be set up as a virtual secure element in the manner disclosed in the co-pending patent application (owned by the assignee of the present application) entitled “System and Method for Providing A Virtual Secure Element on a Portable Communication Device,” U.S. patent application Ser. No. 13/279,147, filed on Oct. 21, 2011 and hereby incorporated by reference.

### Dynamic Temporary (e.g. One-Time) Payment Via a Smartphone

Because some point-of-sale equipment does not accept NFC payments and some users don't have established contactless-enabled payment accounts (e.g. MasterCard PayPass, Visa Paywave), the present invention enables any portable communication device (including those with NFC capability but without a Secure Element and devices without NFC capability) to make highly secure electronic payments at merchants that accept either contactless payments or barcode electronic payments via their existing point-of-sale equipment.

In order to use the system for a dynamic temporary (e.g. one-time) payment to a retailer, the consumer will have downloaded a dynamic temporary (e.g. one-time) payment wallet application and have at least one existing account with a specified bank. The consumer should also have registered the at least one account with payment issuer 310 (which may also be the specified bank). In addition, the consumer should also have a mobile data service for their smart phone (or portable communication device 50).

The dynamic temporary (e.g. One-time) payment wallet 160 may remove some of the complexity involved in the storage, maintenance and use of credentials because of the temporary nature of the credentials and its combination with geo-location confirmation. Among the potential actions that may be controlled by Payment Wallet 160 are those associated with:
a. wallet management (e.g., set, reset or enable wallet passcodes; get URL of OTA server; over-the-air registry provisioning; set payment timing; increase payment timing; set default card; list issuers, memory audit; determine SE for storage of credential; update wallet status);
b. credential management (e.g., add credential; view credential detail; delete credential; activate credential (for redemption/payment); deactivate credential; lock/unlock credential; require passcode access; get credential image; set access passcode); and
c. Secure Element (SE) Management of physical and/or virtual Secure Element(s) for use by Payment Wallet 160 (e.g., get credential; update credential; update meta data; delete credential; wallet lock/unlock; SE lock/unlock, SE initialize/wipe/reset) as disclosed by Applicant's co-pending application Ser. No. 13/279,147 entitled “System and Method for Providing a Virtual Secure Element on a Portable Communication Device,” filed on Oct. 21, 2011, which is hereby incorporated by reference. In a device 50 that does not have a secure element, this SE management may use various techniques to protect the dynamic credential received, including the encryption of standard memory under a user password.

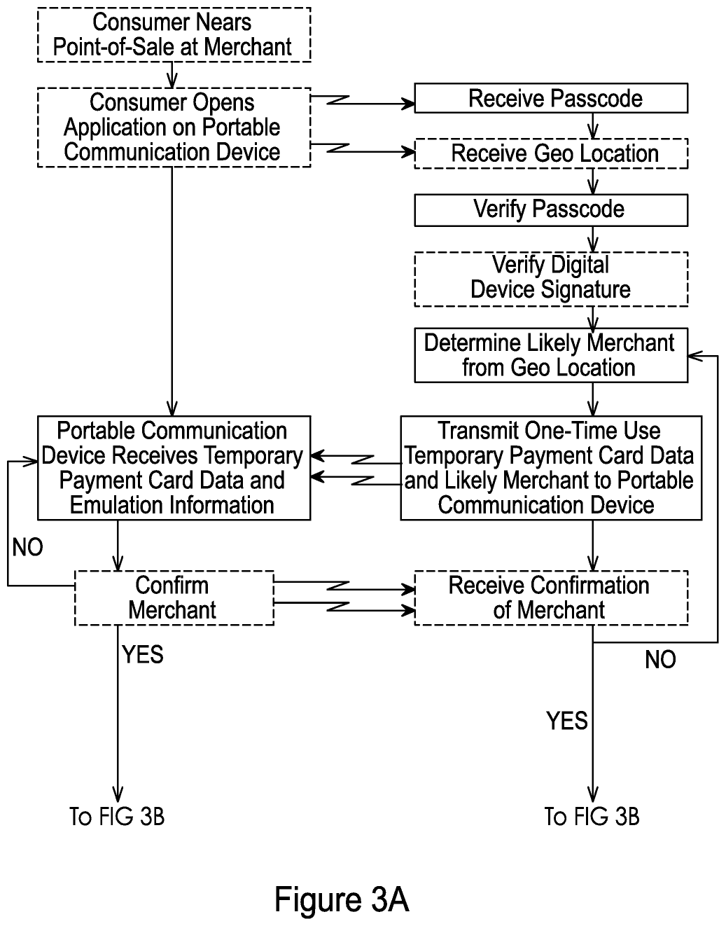

FIGS. 3A-3B together illustrate one potential embodiment (with various potential alternatives) for a process for obtaining and using a one-time (i.e. dynamic temporary) payment credential using the “one-time” payment wallet 160. The consumer may enter a physical retail store with their smartphone (i.e. portable communication device 50) and go about their shopping experience as normal. With the one-time payment wallet 160 downloaded on their smartphone 50, when the consumer is ready to check out of the physical retail store, the consumer may use their smart phone to pay even with a legacy system by opening a solution-enabled smartphone application.

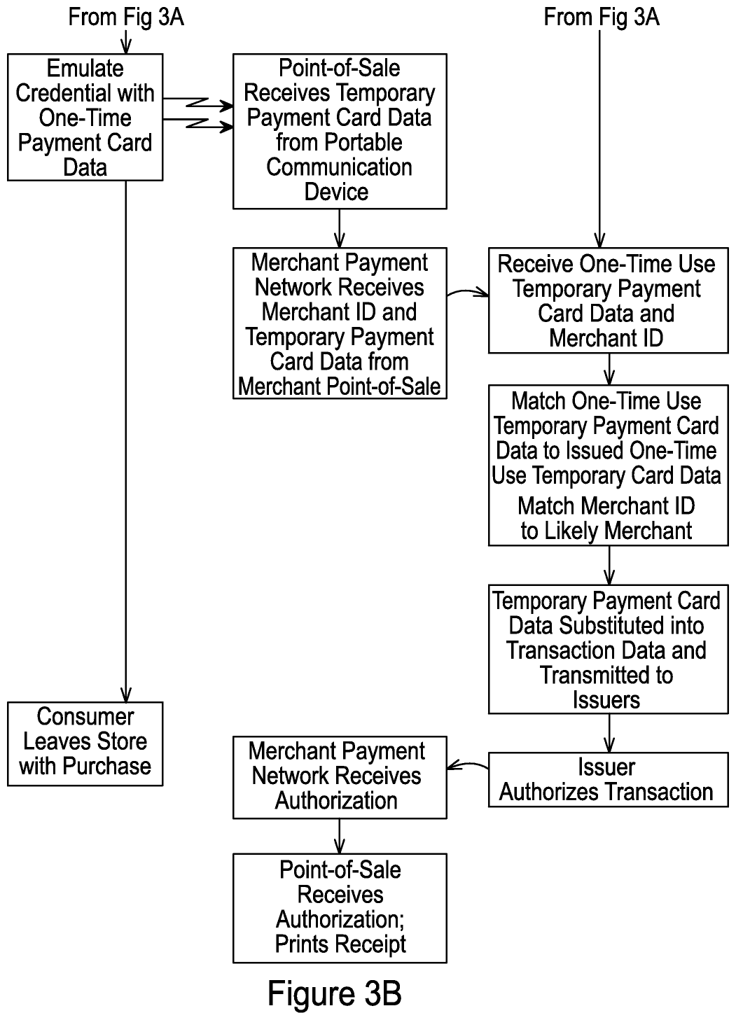

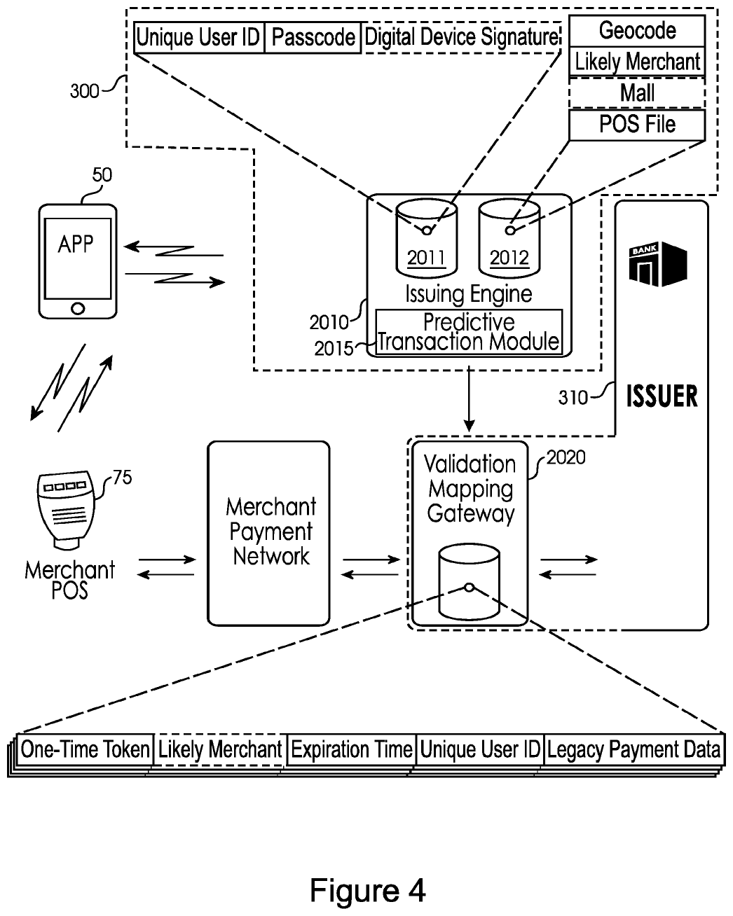

In the embodiment of FIG. 3A-3B, the consumer approaches the point-of-sale 75, opens the one-time payment wallet 160 on smartphone 50, enters the consumer's password/passcode via the user interface on the one-time payment screen (see FIG. 5). The one-time payment wallet 160 sends the consumer's passcode and geo-location coordinates (as generated by the location identification service 165, FIG. 2) to the issuing engine 2010 (FIG. 4). In one embodiment, one-time payment wallet 160 may also provide an ability for the consumer to communicate the estimated amount of the upcoming payment to the issuing engine 2010 prior to generation of the temporary payment card information. By incorporating information regarding the estimated amount of the one-time payment into the confirmation process, additional security for the one-time code may be provided.

In the embodiment of FIG. 3A-3B, the issuing engine 2010 verifies the passcode (e.g., using the user unique identification database 2011). Receipt of the correct passcode indicates to the system that the consumer will be making a payment within a short predetermined period of time (on the order of a few minutes, which could be extended in certain circumstances). The issuing engine 2010 uses the geo location coordinates received from the portable communication device 50 to determine the likely merchant and looks up the merchant's point-of-sale details in a database operably associated with the issuing engine 2010 (e.g., the merchant-geolocation collection database 2012). In particular, based on the geo-location information received, the issuing engine 2010 performs a database query to determine which contactless point of sale terminal is installed (or likely to be installed) at the consumer's location. In a preferred embodiment, the portable communication device 50 may also display a list of the next most likely retail stores (e.g. the next top five) where the portable communication device 50 may be located (see, e.g. FIG. 6A). Based on the identified location and/or point of sale terminal, the card services module of the portable communication device 50 may lookup in a database or otherwise infer the merchant or facility at which the consumer is located and configures the payment system 150 with the data formats and other contactless point of sale or access data specific to this location and/or merchant such that the device 50 is supported or optimal presentation of card, coupon, ticket or access control emulation. The system may also identify to the consumer new card products available for that geo-location that the consumer does not already have loaded in payment libraries 110. In some embodiment, the system may load needed libraries.

The issuing engine 2010 includes a database (e.g., the merchant/facility geolocation collection database 2012) of electronic-payment accepting merchants and supported access-controlled facilities, which may include the merchant location, facility identity, merchant identification number used in electronic payments, the payment schemes accepted by each merchant location, and the capabilities of each merchant location's point of sale or access control equipment capabilities. (See Table 1 below). Although merchant/facility geolocation collection database 2012 is described as being included within or otherwise part of the issuing engine 2010, it is conceived that the merchant/facility geolocation collection database 2012 may be included within, part of or associated with the portable communication device 50, the issuer 310 or separately hosted. Moreover, it is further contemplated that the merchant location may further include the merchant's altitude. It should be appreciated that merchant/facility geolocation may be represented using map coordinates but could effectively also be representated using street address or proprietary coordinates relative to a surveyed baseline or point. It should be appreciated that the alititude of the merchant/facility may be represented as a physical length measure or distance measure (e.g. feet, meters) with reference to a recognized international map datum (e.g. WGS84) but could also effectively be represented in relative terms such as height above ground level, floor number, or proprietary coordniates relative to a surveyed height reference.

TABLE 1
Examples of Merchants and One-Time Payment Information

| | Merchant | | Legacy | Legacy | |
|---|---|---|---|---|---|
| Merchant | Location | Merchant Location | Merchant ID | Payment/ | Equipment |
| Name | GPS (Lat./Long.) | Address | Number | Access Type | Capability |
| Grocery Land | 37.48 N, 122.24 W | 100 Marine Parkway | XQ24MZ122A | Bar Code | Laser Scanner |
| | | Suite 400 | | | |
| | | Redwood City, CA | | | |
| | | 94065 | | | |
| Appliance | 37.48 N, 122.24 W | 110 Marine Parkway | YF234XY302 | QR Code | Optical QR |
| Land | | Redwood City, CA | | | Code Reader |
| | | 94065 | | | |
| Must Buy | 37.48 N, 122.24 W | 120 Marine Parkway | MN343D | ISO/IEC | ISO/IEC |
| | | Redwood City, CA | | 14443/NFC | 14443 |
| | | 94065 | | | Contactless |
| | | | | | Reader |

The issuing engine 2010 then generates the one-time use temporary payment card and transmits the temporary payment card data and identity of the likely merchant to the portable communication device 50 over-the-air. This temporary payment card information may be formatted in real time using existing standards and practices of the legacy electronic payment industry, including personal account number, issuer identification number, ISO/IEC 7812 (relating to the identification of issuers using an issuer identification number (IIN) to operate in an international, inter-industry, and/or intra-industry interchange), ISO/IEC 7813 (relating to the data structure and content of magnetic stripe tracks used to initiate financial transactions), and ISO 8583 formatting (which is a business messaging protocol, based on a proprietary standard).

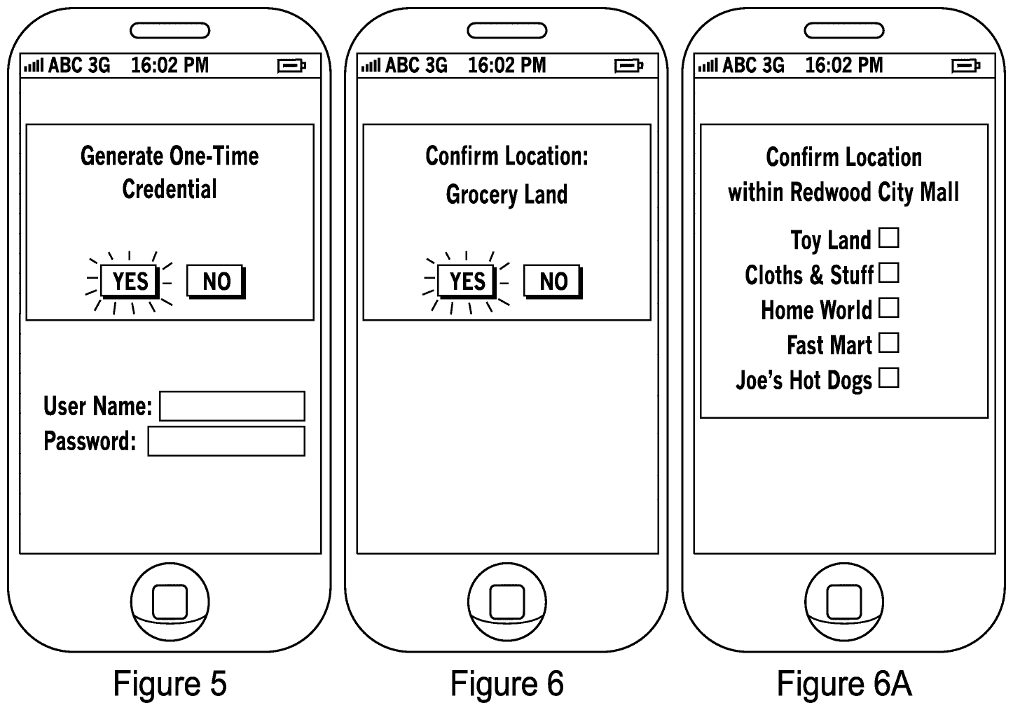

In one preferred embodiment, the one-time payment wallet 160 formats the temporary payment card based on the capabilities of the portable communication device 50 as well as the capabilities of the merchant's point-of-sale equipment 75. The temporary payment card information may also be formatted in multiple formats to provide the consumer with options that may be presented to the merchant cashier. FIGS. 7A and 7B illustrate two of the possible types of one-time payment codes that can be transmitted to the portable communication device 50. FIG. 7A depicts the one-time payment code as a 1-D bar code. As would be understood by those of ordinary skill in the art this bar code could be a 2-D matrix code or stacked linear barcode (e.g. QR code, Datamatrix, EZCode, PDF417). FIG. 7B depicts the one-time payment code as a numeric code, which may be 16 digits as shown or a different length as desired.

One format that the temporary payment card information may be rendered on the smartphone display is an ISO/IEC 7813 compliant number (i.e., PAN) that the clerk at the merchant enters by hand into the merchant point-of-sale. Another format that the temporary payment card data may be rendered on the smartphone display in barcode (ISO/IEC 15426-1), 2-D barcode (ISO/IEC 15426-2), QR code (ISO/IEC 18004:2006), or other such similar methods that transmit ASCII, alphanumeric, or numeric data, then captured by the optical scanner of the merchant's point of sale. Yet another format that the temporary payment card data may be rendered using NFC Peer-to-Peer mode (ISO/IEC 18092), NFC Tag Emulation (NDEF, ISO/IEC14443, MIFARE, and Felica), or NFC Card Emulation mode (ISO/IEC 14443 card emulation) or RFID modes. Further, another format that the temporary payment card data may be rendered using sonic or hypersonic audio carrier generated by the portable device speaker and received by an accessory appliance at the merchant point of sale terminal.

The activated temporary payment card data expires after a short predetermined period of time, such as two (2) minutes to provide further security. This time could be extended as long as the issuer is willing. It is believed that less than 30 minutes, or even less than 20 minutes or even 10 minutes would be preferred. Other expiration times can be used and/or programmed as desired.

The portable communication device 50 receives the temporary credential data, likely merchant, and emulation information from the issuing engine 2010. In a preferred embodiment, the portable communication device 50 confirms the likely merchant was correctly selected from database 2012. In one approach illustrated in association with FIG. 6, the portable communication device asks the user to the confirm the location. In the illustrated example, the user interface asks whether the location is “Grocery Land”? As the consumer is shown in FIG. 1A standing in Grocery Land, the consumer should select the “yes” button on FIG. 6. If the system has selected the wrong retailer, the system may provide alternatives for ascertaining the correct retailer. For example, FIG. 6A depicts the provision of a list of potential merchants close to the consumers' proximity in an example where the one-time credential was requested from within what the issuing engine 2010 recognized as a mall (or other high-density grouping of merchants). As would be understood by those skilled in the art having the present specification, drawings, and claims before them, the list of nearby merchants need not be limited to those merchants within a single mall. Alternatives may be selected from other retailers that were geographically close to the geo-location received by the server. As would be further understood, the alternatives may be presented to the end user in the form of a pull-down menu or list, as an example, as a map overlay showing geographical location of each retailer, as a floor plan overly, such as used in a mall, plaza, or building directory, or other situationally relevant forms.

In an embodiment where the consumer uses portable device 50 to confirm the merchant, the confirmation of the likely merchant may be received by issuing engine 2010. If the likely merchant was identified incorrectly, then the issuing engine may issue new emulation information to the portable communication device 50. Once the likely merchant is known, the predictive transaction module 2015 of issuing engine 2010 transmits the ID for that likely merchant, the unique user ID associated with portable communication device 50, the one-time use token generated for the transaction, and the expiration time to the validation mapping gateway 2020.

The validation mapping gateway 2020 may be physically hosted by a bank, by an issuer 310, or by a payment processor network and may be deployed as either a service or as a sub-system installed and integrated at existing transaction processors, card schemes, financial institutions, and other entities. Upon receiving the data from the predictive transaction module 2015, the received data is stored in a database associated with the validation mapping gateway. Where such data is provided, the temporary data may be associated with the legacy card data previously associated with the unique user ID. To the extent such associations exist, mapping legacy card-to-unique user ID, it may be created by the issuers 310 or even by the consumer in an electronic transaction directly between the portable communication device 50 and the validation mapping gateway 2020 orchestrated by the system management back end 300.

In a preferred embodiment, the predictive transaction module 2015 send the data to the validation mapping gateway 2020 at substantially the same time one-time use credential information is being transmitted to the portable communication device 50. In this approach, the validation mapping gateway 2020 can anticipate the consumer transaction from the merchant POS 75 via the merchant payment network. In particular, in such an embodiment, the Validation mapping gateway 2020 may use the time between receiving data from the predictive transaction module 2015 and receipt of the transaction from the retailer point-of-sale 75 to bring stored data out of the large database and into a memory that provides for quicker access (in comparison to the access time from a large database) and comparison between the stored data and the data received from the merchant payment network. In this approach, the addition of this additional verification step in the validation mapping gateway 2020 will create less latency than may have otherwise been caused by the need to locate and retrieve the data for this comparison after receiving a transaction from the POS 75.

So returning to the consumer, after the portable device 50 has received the temporary credential and emulation information, the consumer may then tap or otherwise activate the smart phone 50 on the NFC peer-to-peer-enabled point of sale device 75, which causes the portable communication device to emulate the credential with the one-time payment code using the emulation protocol provided by the server. It being understood that the code may be visually “emulated” on the screen of the portable communication device 50. Because the temporary payment card data may be provided in legacy formats, the temporary payment card data may be accepted by existing merchant point-of-sale equipment 75.

The point of sale device 75 then processes the temporary payment card data through normal merchant payment network as if it were a standard credit or debit credential. However, because the temporary payment card data uses Issuer Identification Numbers (ISO/IEC7812) that were registered and mapped to the one-time payment system provider as the Issuer, the data will be routed to the validation mapping gateway 2020 via the merchant payment network. If the data is received by the validation mapping gateway 2020 prior to the expiration of the expiration time for the temporary credential and from the anticipated likely merchant, then the validation mapping gateway 2020 may authorize the transaction. The validation mapping gateway 2020 may also compare the method by which the temporary payment card data was entered into the merchant point-of-sale device 75 (existing ISO8583 specified field) with the method the temporary card data was provisioned for intended use to the mobile phone (e.g. Numeric code, barcode, NFC).

Again, if all the desired characteristics support a low risk score (e.g. temporary code, execution time, merchant ID, and emulation type), the validation mapping gateway may return a confirmation to the merchant with authorization code via the merchant payment network or facility access network. The merchant point-of-sale 75 receives the authorization (i.e. confirmation of payment acceptance with authorization code), prints a receipt, and the consumer leaves the store with their newly acquired items or user is granted access to the controlled facility.

Alternatively, upon verification of the temporary payment card information (including timing and likely merchant ID), the system has the option to forward an equivalent payment transaction request to an issuer 310 to approve the transaction. This is known as executing a back-to-back payment transaction. In this way, the consumer and merchant would receive payment confirmation from the consumer's legacy bank credit card or debit card account, instead of the temporary card number. In particular, once the one-time payment transaction is confirmed, validation mapping gateway 2020 substitutes legacy card payment data in the transaction data, which is then passed onto the issuer authorization systems 310 along with standard POS transaction information (e.g. merchant ID, and transaction amount) and—in some embodiments—an indication that the transaction used a verified one-time use credential (to show an added measure of security). The issuer 310 will review the legacy card data and transaction information toward determining whether to authorize the transaction in a manner generally known in the art perhaps with the information that the transaction had the added security noted above. The issuer authorization is sent back to the merchant point-of-sale 75 via the normal existing processing channel.

This one-time (or temporary)-use credential solution can be used for many different types of credential validation scenarios including: credit card and debit card payments, gift card, loyalty card, coupons and offers, access control, transit fare, event ticketing, and any other environment where a consumer presents a credential for validation in a physical environment.

While the functionality may be integrated within one-time payment wallet 160, the user interface may be provided by wallet user interface and the over-the-air provisioning and management of and access to the secure payment subsystem is supported by the functionality of the card services module. Underlying the user interface, the card services module facilitates over-the-air provisioning, secure element management, and direct key exchange between the card services module on the user's mobile device 50 and the appropriate issuer server (for one-time payment wallet 160 that would be issuing engine 2010) in an encrypted fashion as was previously known in the art.

### Validating One-Time Payment Application as a Third Party Application

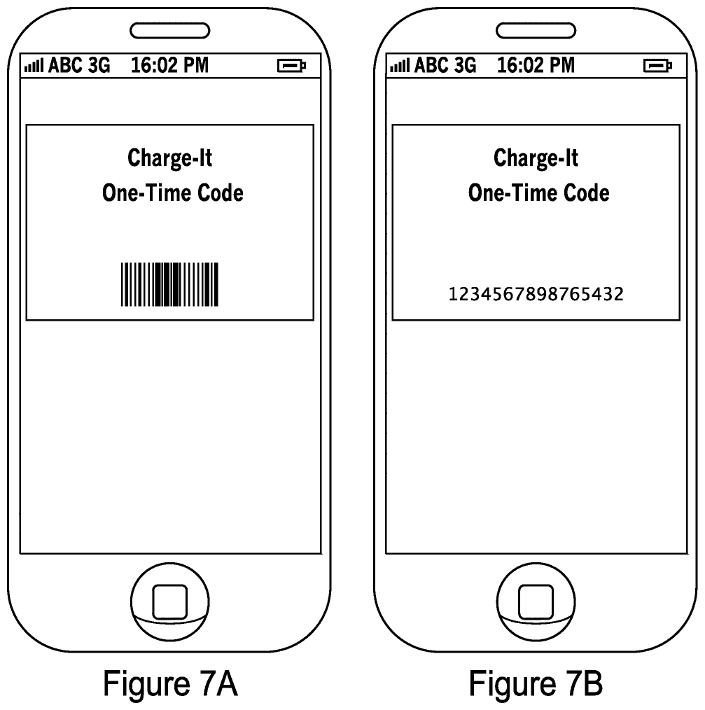

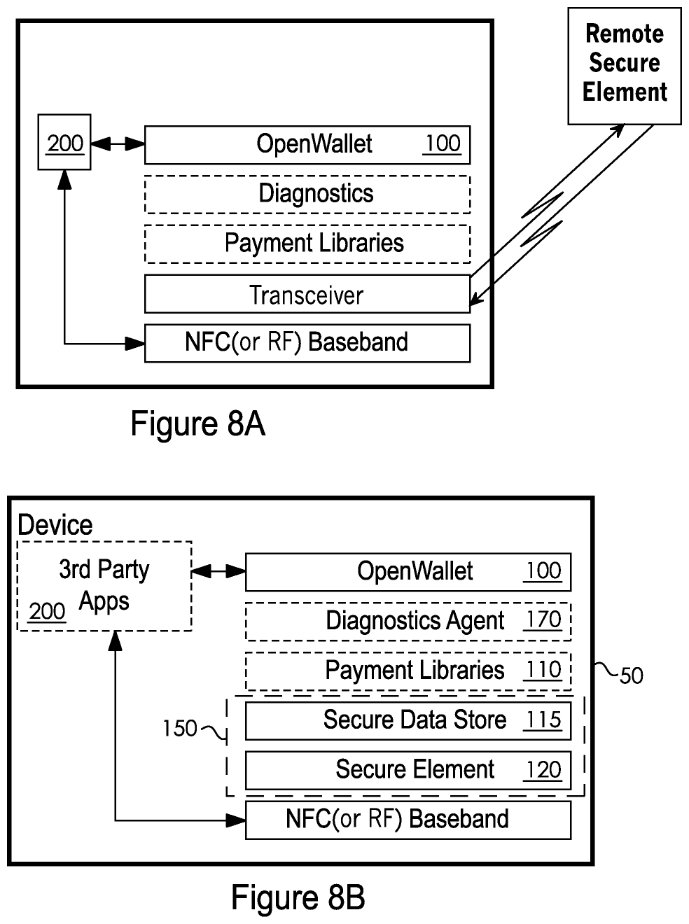

As illustrated in FIG. 8A-8B, the one-time payment wallet 160 may be deployed as one of many trusted third party applications 200. The card services module verifies the trusted status of any application 200 before that application is allowed access to the secure element 120, (or secure data store 115 and even preferably the meta data repository which stores, among other things, card image data and any embossed card data) on the portable communication device 50 to view, select and/or change secure data stored in the payment subsystem 150. This verification may be accomplished by accessing a local authorization database of permitted or trusted applications. In a preferred approach, the local authorization database cooperates with a remote authorization database associated with one or more servers associated with system management back end 300. Applications may be identified using various means, including technology platform facilities such as strong assembly references, hash coding of the application's executable code or load file, an app developer's API key or oAuth token, and other means known to those of ordinary skill in the art of smartphone application development.

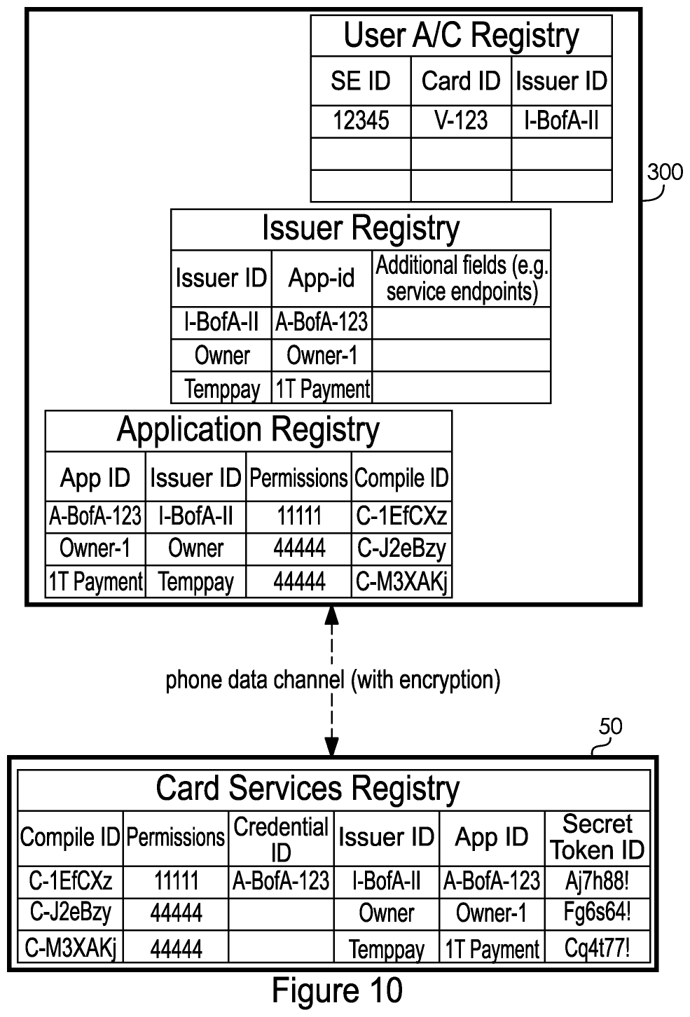

FIG. 10 is a block diagram of one potential implementation of one potential combination local and remote authorization databases to enhance security of the card services module, secure element 120, and payment subsystem 150. As shown in FIG. 10, a User A/C Registry (or User Account Registry) may be associated with the server (or otherwise deployed in the cloud). The User A/C Registry may store the identification of the secure element 120 disposed in each user's portable device 50. Entries in the User Account Registry may be added for each user at any point in the process.

The “Issuer Registry” database is a database of approved Issuers. The Issuer ID is unique for each type of credential. In other words, if a bank has multiple types of credentials (e.g. debit cards, credit cards, affinity cards, etc.) each credential type would have its own Issuer ID (e.g. I-BofA-II). In a preferred approach, the Issuer ID as between multiple types of credentials would have some common elements, so as to indicate that the credentials are at least related (e.g. I-BofA-I). In this way applications from same the issuer can share data with the other application of the same “extended” issuer. In a preferred approach, card services module can be simplified by requiring even the wallet user interface (which “ships with the system”) to have an Issuer ID (and as well as an Application ID and Compile token).

The “Application Registry” is a database of applications (mostly third party) that have been pre-approved by an operating system provider. Like the User A/C Registry, the “Application Registry” and “Issuer Registry” database are maintained on the server side (or otherwise hosted by a third-party Internet-connected facility) in operable association with the one-time payment application. As would be understood by those of ordinary skill in the art having the present specification before them, the various registries may be implemented in separate databases or one unified database. At initiation of a wallet 160 and preferably at substantially regular time-intervals thereafter (e.g., daily), the data stored in the Application Registry of the one-time payment wallet 160 is distributed to devices with the wallet to be stored locally.

As shown in FIG. 10, the Application Registry may include, among other information, an Application ID (“App ID”), an Issuer ID, and a Compile ID or token. The Compile ID is a global constant generated for each application by one or more processes associated with one-time payment wallet during the qualification process for the particular application. After it is generated by a particular card services module on a unique device 50, the Compile token is included or otherwise associated with the application. This Compile token is preferably generated by a pseudo-random number generator local to the device that uses a pre-determined seed, such as the Application ID, Compile ID, Issuer ID or some combination thereof.

When the user seeks to qualify an application with the card services module on a device 50, the Compile ID (a digital token) and Application ID (a digital identifier) associated with the third party application may be matched against the Compile ID and Application ID pairs stored in the Card Services Registry stored on the device 50 (see FIG. 10). As should be understood by those skilled in the art having the present specification before them, the same Compile and Application ID pairs are transmitted to other devices 50 associated with the system, as well. If the Compile ID/Application ID pair matches one of the pairs stored in the Card Services Registry on the device, a Secret Token ID is preferably generated on the device 50 by a pseudo-random number generator (such as the one associated with the Secure Element 120 and then stored in association with the Compile ID/Application ID pair in the Card Services Registry on the device 50. In some instances, the Compile ID may be pre-selected and used to seed the random number generator. It should be understood that one or more pieces of other predetermined data associated with the card services registry could be preselected as the seed instead. The Card Services Registry is preferably stored in secure memory (rather than the secure element 120 because secure element 120 has limited real estate) and the Card Services Registry is preferably further encrypted using standard encryption techniques. The Secret Token ID is also embedded in or otherwise associated with the application 200 on the device 50 in place of the Compile ID that was distributed with the application.

After the one-time payment wallet 160 has been loaded into the Card Services Registry (and the secret token embedded in the application), the one-time payment wallet 160 may launch and may prompt the user to opt-in to provide access to the issuer-specific credential needed for the validated (or trusted) application. In each subsequent launch of the one-time payment wallet application 160, the embedded Secret Token and/or Application ID are compared to the data in the Card Services Registry on the device. If there is match, the application is trusted and can access the payment subsystem 150 via card service module. In this manner, it can be seen that applications 200 or wallet user interface may also be removed from the Card Services Registry and thus would be disabled from accessing the payment subsystem and possibly the application, altogether.

Card services module also preferably uses the trusted application verification step to determine the appropriate level of subsystem access allowed for the one-time payment wallet 160. For example, in one embodiment, the application may be authorized to access and display all of the data contained in the payment subsystem 150, where another application may be only authorized to access and display a subset of the data contained in the payment subsystem 150. In yet another embodiment, an application may be permitted only to send a payment or transaction requests to one-time payment wallet 160, but may not itself be permitted to access any of the data contained in the payment subsystem 150. In one approach, assignment of permissions to the application can be thought of as follows:

| | | All | Extended Issuer | Own |
|---|---|---|---|---|
| | Reserved | Credentials | Credentials | Credentials |
| Read | 0 | 0 or 1 | 0 or 1 | 0 or 1 |
| Write | 0 | 0 or 1 | 0 or 1 | 0 or 1 |
| Delete | 0 | 0 or 1 | 0 or 1 | 0 or 1 |
| Activate/Deactivate | 0 | 0 or 1 | 0 or 1 | 0 or 1 |
| Download Creden- | 0 | 0 or 1 | 0 or 1 | 0 or 1 |
| tial | | | | |

These permissions can be used to form 4 hexadecimal number in the order shown above from most to least significant figure. As shown in the example Card Services Registry of FIG. 10, the I-BofA-II issuer has permission level 11111, which can be thought to expand to 0001 0001 0001 0001 0001. In other words, the I-BofA-II application can read, write, delete, activate/deactivate, and download its own credentials but not the extended issuer credentials let alone all credentials. If BofA had another issuer code (e.g. I-BofA-I), then that would be an extended Issuer application. So, if the permission level of the application associated with Issuer ID “I-BofA-II” was set to 0010 0001 0001 0010 0001 (or 21121 hexadecimal) then the application would be able to read and activate/deactivate the credentials associated with both issuer IDs. In yet another example, the wallet user interface may be given a permission level of 44444 (i.e. 0100 0100 0100 0100 0100). In other words, the wallet user interface can read, write, delete, activate/deactivate, and download all credentials. As would be understood by those of ordinary skill in the art, these are merely examples of potential permissions that can be granted to applications, other permissions are contemplated. For instance, some applications may have the ability to read extended issuer credentials, but only write, delete, activate and download the application's own credentials (e.g. 21111, which expands to 0010 0001 0001 0001 0001). In yet another example, an application may only be given activate/deactivate and download rights (e.g. 0000 0000 0000 0001 0001 or 00011 in hexadecimal). In yet another example, an application may be disabled—without being deleted from the trusted application database or Card Service Registry—by setting all rights to zero.

In the embodiment where the one-time payment wallet application 160 is configured as one of the trusted third party applications it would have to be registered in order to access OpenWallet 100 (or even card services module). The one-time payment wallet application 160 was developed by the issuer associated with issuing engine 2010. Further the one-time payment wallet application 160 may emulate NFC credentials. Accordingly, one-time payment wallet application 160 should be given a permission level 11111, which can be thought to expand to 0001 0001 0001 0001 0001. In other words, the one-time payment wallet application 160 can read, write, delete, activate/deactivate, and download its own credentials but not the extended issuer credentials or any other credentials.

The foregoing description and drawings refer to a one-time payment wallet 160, and one-time payment credentials or information or temporary payment card data that expires after a short predetermined period of time. It is recognized, however, that the one-time payment wallet 160 may instead be considered a dynamic temporary wallet 160 and that the one-time payment credentials/information and the temporary payment card data may be considered dynamic temporary credentials. As such, credentials may (1) be “recycled” and reused within the system by other users; (2) have a predetermined time to live that is longer than a “short” predetermined period of time and (3) that such credentials can be used for more than simply purchasing merchandise. It is further contemplated that although the foregoing description and drawings primarily refer to a point of sale device 75 associated with a merchant, the foregoing description, drawings and embodiments, can be applied to a variety of other electronic control points such as hotel room transceivers, office transceivers, rental car transceivers, etc. For example, electronic control points may include any access point such as point of sale devices, RFID transceivers, bar code transceivers, NFC transceivers, etc.

In particular, credentials must generally be “paid for” by an issuer 310 or other organization within the overall larger merchant payment system. As such, systems may only have a limited number of credentials at its disposal. Using such credentials only one-time for a particular user and transaction can lead to unnecessary high costs compared to a system wherein payment credentials are recycled for use by multiple users at disparate times and, preferably in disparate geo-locations to provide additional security against fraud. For example, issuing engine 2010 may track the issuance of and expiration data associated with credentials to a first user operating a first portable communication device 50 located in a first geolocation (e.g., California) and, subsequent to the expiration date and time of the credentials, reassign the very same credentials to a second user operating a second portable communication device 50 located in a second, disparate geolocation (e.g., Florida).

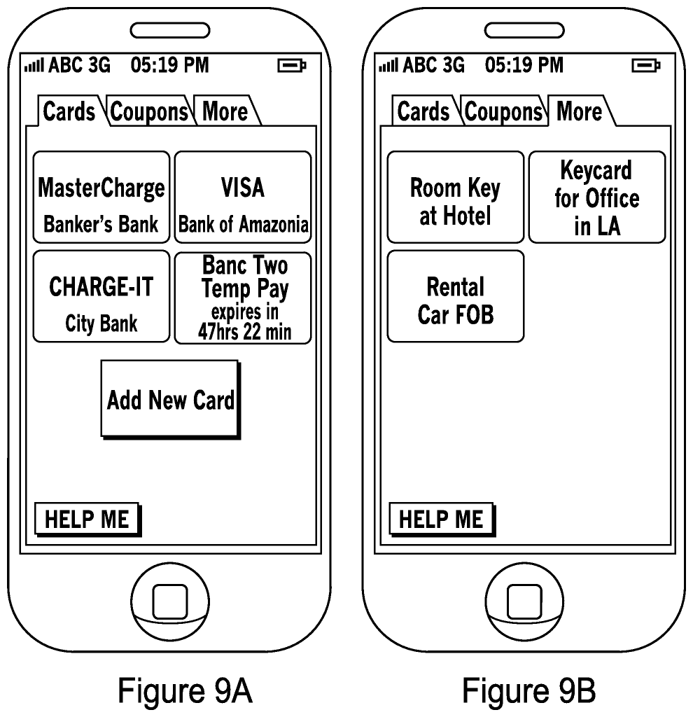

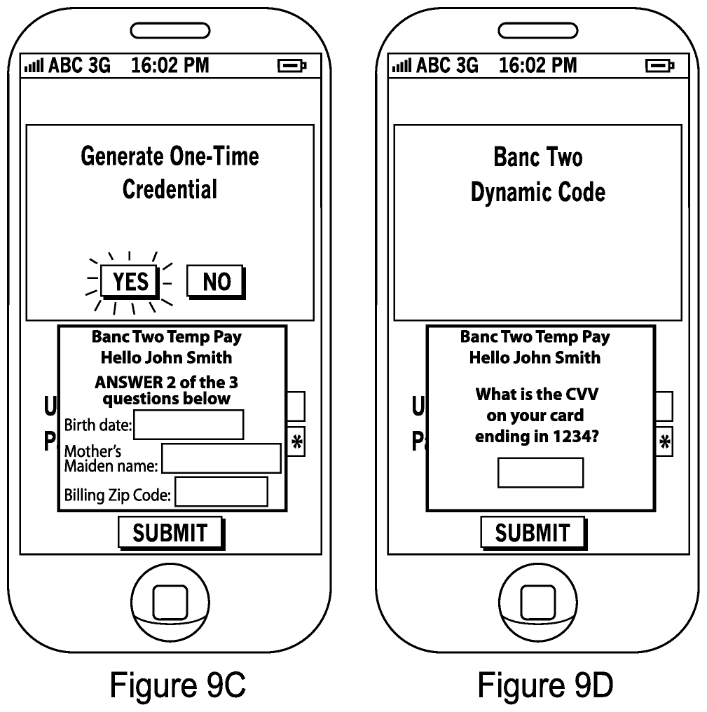

Similarly, credentials may have longer time to live periods to permit the use of the credentials at a variety of “points of sale” or other electronic control points. For example, with reference to FIG. 9A and 9B, an exemplary wallet user interface is illustrated on a portable communication device 50. Wallet 160 may include and be associated with a variety of payment cards (e.g., MasterCharge, VISA, Charge-It, etc. as illustrated in FIG. 9A) and may further include and be associated with a variety of other non-payment applications (e.g., a room key at a hotel, an office keycard, a rental car FOB, etc. as illustrated in FIG. 9B). While the “time to live” period is preferably short in the context of a sale at a point of sale to provide enhanced security, it is contemplated that the “time to live” may be significantly longer when wallet is associated with non-payment applications such as a room key at a hotel. In such an example, the wallet 160 may be used to “open” or “lock” a user's room at a hotel. Thus, the “time to live” should be set to be at least coextensive with the user's stay at the hotel. Similarly, the time to live can be set to a period of time (infinite if necessary) to permit the user of device 50 to use the device 50 to access an office or a rental car.

It is therefore also contemplated that the system management back end 300 and issuer 310 may be associated with non-financial services to permit the usage of non-payment wallet applications. For example, system management back end 300 may include data relevant to non-financial services (e.g., hotel location, office location, etc.) and that issuer 310 may be affiliated with non-payment entities (e.g., hotel entities, office management entities, etc.).

An issuer of an electronic payment card may be willing to support extended life dynamic credentials perhaps in certain select circumstances. For instance, a user may wish to make a purchase using a payment credential, but a point of sale terminal may not be connected to a payment network at the time of purchase. Such transactions may be referred to as “offline” transactions. For example, a user may make an in-flight purchase during an airline flight at a point of sale terminal. At some later time, the point of sale terminal may communicate the received payment credential to a payment processing network to request payment from the customer's account. In other instances, the users may desire a temporary payment credential for use from their homes in association with internet-based (or other computer networked commerce) transactions. In still other examples, a user may simply prefer to obtain a temporary payment credential from the comfort of their home, so as to avoid the stress of having to obtain a credential at the right moment in line at the checkout of a retail establishment.

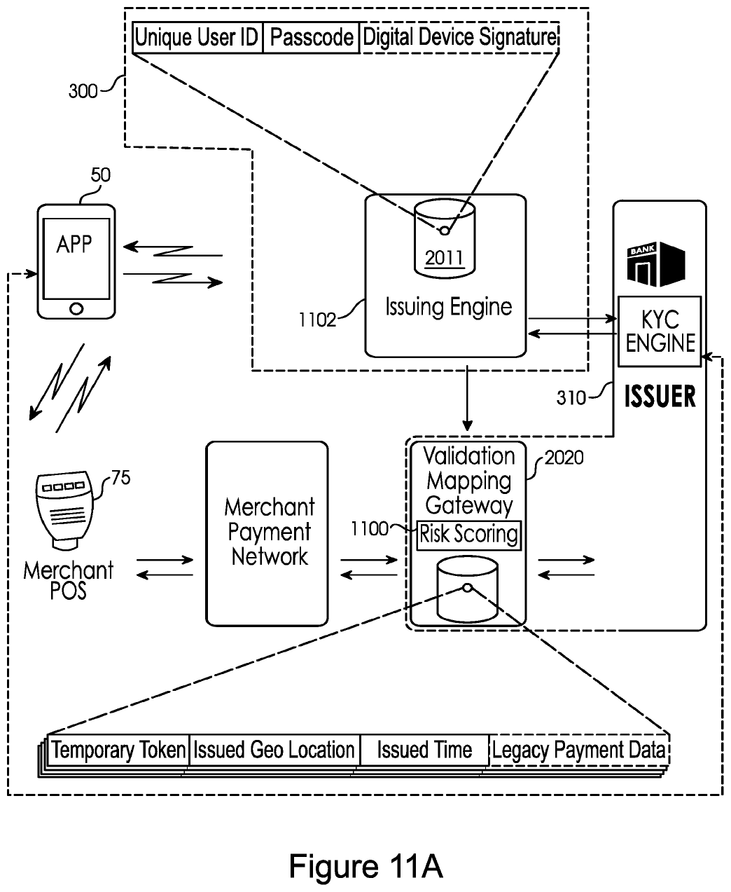

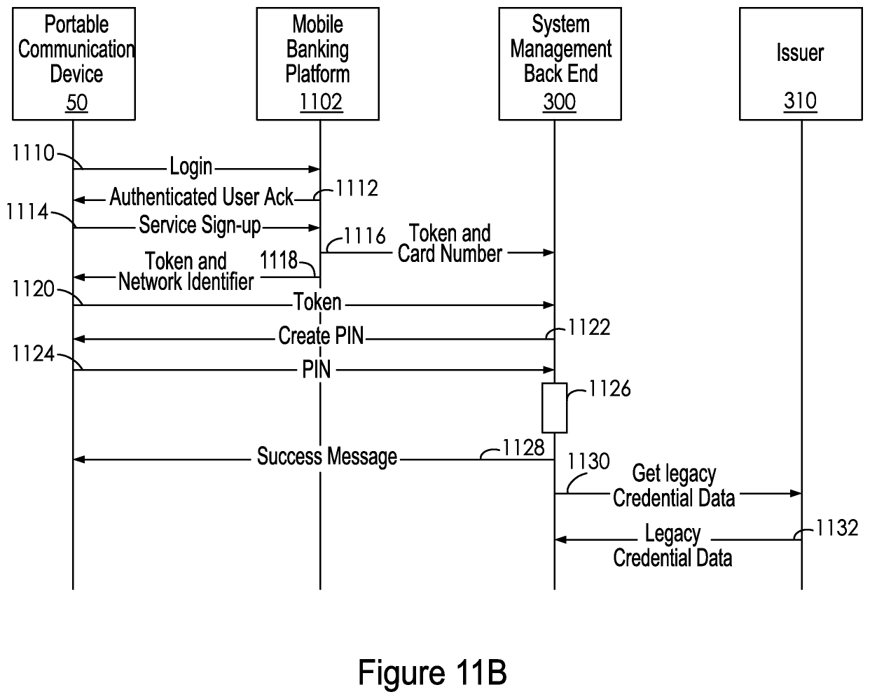

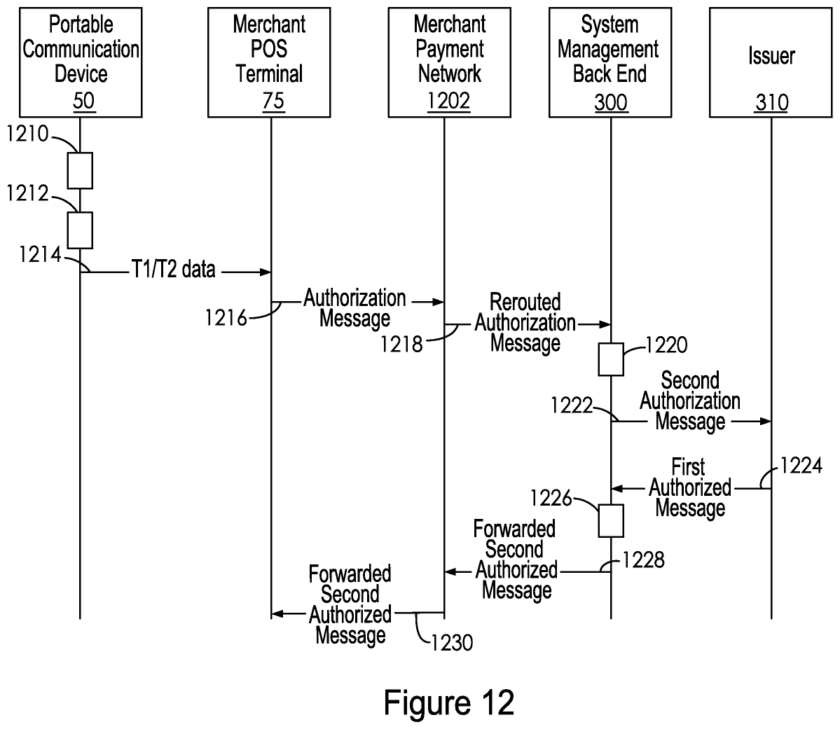

FIGS. 11A, 11B and 12 together illustrate one potential communication flow to obtain a temporary credential and use that credential to make a payment. In this potential embodiment, a user may initiate a sign-up process using their wallet application to obtain a temporary payment credential from the cloud. The user may have an account (e.g., credit card account debit account, etc.) with a bank (or other financial account provider), and may desire to sign-up for a payment service offered by the bank that permits the user to make payments with temporary payment credentials using their portable communication device 50. For instance, as illustrated in FIG. 9A the user may obtain a “Temp Pay” card from “Banc Two” by launching the temporary payment wallet application stored on portable communication device 50 that has been previously verified as a trusted application (preferably in the manner illustrated in association with FIG. 10 above). When the temporary payment wallet application 160, the embedded Secret Token and/or Application ID are compared to the data in the Card Services Registry on the device a local match will enable communication with the mobile banking platform or issuing engine 1102 (see FIG. 11A).

Once the user is authenticated, the temporary dynamic wallet application 160 may generate track data based on the type of temporary payment credential, user data, and contextual data when the user requests the temporary credential. This temporary payment card data may preferably be formatted with existing standards and practices of the legacy electronic payment industry, including personal account number, issuer identification number, ISO/IEC 7812 (relating to the identification of issuers using an issuer identification number (IIN) to operate in an international, inter-industry, and/or intra-industry interchange), ISO/IEC 7813 (relating to the data structure and content of magnetic tracks used to initial financial transactions), and ISO 8583 formatting (which is a business messaging protocol, based on a proprietary standard). In some examples, the payment data may be arranged in a format similar to that of track 1 and track 2 data from a conventional credit card, so that the payment data may be processed by a legacy point of sale terminal. In an example, the payment data may include a data block formed with some or all of the following fields (32 digits): Account # (9 digits); IMEI (device identifier—11 digits); Expiry date (4 digits); Random number (6); and Sequence counter (2). The data block may also include one or more padding characters.

FIG. 11A illustrates an example communication flow permitting a user to sign up and obtain a temporary payment credential in one potential embodiment of a process. The user may cause their portable communication device 50 to retrieve a wallet application from a mobile banking platform (or issuing engine) 1102 associated with the user's financial account provider, and may create login information that may be subsequently used for authenticating the user. In element 1110, when a user desires to obtain a temporary payment credential, the user may cause portable communication device 50 to open the wallet application and may input the login information. The login information may be, for example, a username and password. If the user has multiple accounts, the user may select a particular one to connect to the temporary payment system. In this embodiment, the issuing engine 1102 may also receive the geo location coordinates received from the portable communication device 50 at the time of this request for later use in association with a payment transaction.

At element 1110, portable communication device 50 may communicate the login information to mobile banking platform 1102. In certain embodiments, the mobile banking platform 1102 may pass the communication link to the issuer 310 associated with the temporary payment application to ensure that the issuer recognizes the customer. As shown, in FIG. 11A, issuer 310 may have a Know Your Customer (KYC) Engine capable of communicating with portable communication device 50 without the involvement of the back end system 300. In this way, only the issuer 310 and end user are ever exposed to the end user's personal information. In particular, the KYC Engine may be capable of generating a user interface on top of the temporary payment application 160 (see FIG. 9C) from which it can directly receive the user input and verify the customer. As shown in FIG. 11A, in this embodiment, the KYC engine may send an authentication message to the issuing engine 1102.

If the user is successfully authenticated, mobile banking platform 1102 may return, in block 1112, an acknowledgement message indicating that the user has been authenticated. The user may then, in element 1114, use the wallet application to request to sign up for a temporary payment credential service. In element 1116, the mobile banking platform 1102 may generate and communicate a communication security token and a legacy card number to management back end 300. The communication security token may be generated and used in accordance with the systems and methods disclosed in Applicant's co-pending patent application Ser. No. 13/916,307 entitled “System and Method for Initially Establishing and Periodically Confirming Trust in a Software Application” filed on Jun. 12, 2013, which is hereby incorporated by reference.

In element 1118, mobile banking platform 1102 may communicate the token to portable communication device 50 along with a network identifier. The network identifier may identify a network address of management back end 300 for routing messages from the wallet application to management back end 300. In an example, the network identifier may be a uniform resource identifier (URI). In element 1120, portable communication device 50 may communicate the token to management back end 300 using the network identifier. In reply, management back end 300 may determine whether the user has created a personal identification number (PIN) or other authenticating sequence, and, if not, may communicate, in element 1122, a create PIN message to portable communication device 50. A PIN may be a secret shared by the portable communication device 50 and the system management back end 300 for authenticating the user.

The user may input a desired PIN to the wallet application, and portable communication device 50 may, in element 1124, communicate the created PIN to management back end 300. In element 1126, management back end 300 may complete registration of the user and, in element 1128, may generate and communicate a success message to the portable communication device 50. The success message may include a temporary payment credential and one or more risk management parameters. The temporary payment credential, for example, may include randomized card data optionally having a time to live value. In an example, the temporary payment credential may include routing information, a temporary account identifier, and a checksum. In an example, the temporary payment credential may include: 6-digit ISO BIN (International Organization for Standardization Bank Identification Number)+9-digit alternative account identifier+1-digit Luhn check. The time to live value may be configurable to meet the business rules of the financial account provider. For example, the time to live value may have a configurable duration (e.g., seconds, minutes, days, weeks, months, years, etc.) and/or a and may have a configurable usage frequency (e.g., use up to 3 times).

In element 1130, management back end 300 may request the user's legacy credential data and the Issuer 310 may retrieve and respond with the user's actual credential data.

Portable communication device 50 may subsequently use the temporary payment credential to make a purchase, including storing the temporary payment credential for offline usage at a later time. When it is time to pay for a sales transaction, the user selects the temporary payment credential (e.g. Banc Two Temp Pay) from their wallet application. As discussed above with respect to the one-time credentials, the wallet application may communicate the track data and a legacy bank BIN to a point of sale terminal using, for example, via NFC tap or QR code scan. The point of sale terminal may route the track data to its payment processing network, which may process the bank BIN to forward the track data to a third-party Internet-hosted service. Upon receiving the temporary identification, the third-party Internet-hosted service may assess risk, provide a score, and generate request payment authorization from a bank authorization system. If payment is approved, the cloud service may communicate an approval message to the point of sale terminal, thus completing the sale.

FIG. 12 illustrates a payment communication flow using a temporary payment credential in one potential embodiment of a process. When making a purchase, with reference to element 1210, a user may launch the trusted wallet application and select which credential to use to make payment. For example, wallet application may provide access to multiple payment credentials, some of which may be temporary payment credentials and others may store payment credentials storing legacy card data (e.g., actual payment account information). The user may select a temporary payment credential. and enter its corresponding PIN. In element 1212, wallet application may generate payment data for the selected temporary payment credential, which is then provided to the Merchant POS Terminal 75 in the same manner described above in association with FIGS. 7A and 7B. The POS terminal 75 may verify whether the generated data corresponds to an expected format. If it does not, POS terminal 75 may decline the transaction locally. If the format matches expected parameters but the POS terminal is not connected to the merchant payment network, the POS terminal may still approve the transaction offline and complete the sale via the merchant payment network at a later time, in accordance with the following flow.

If the format matches expected parameters and the terminal is connected to the merchant payment network, the POS terminal 75 communicates parameters of the transaction via an authorization message to the merchant payment network. The authorization message may include the Track1/Track2 data, the merchant ID (and preferably the merchant's geo location), and the amount of the transaction. In element 1218, payment network system 1204 may process the authorization message, determine that it contains data for routing to management back end 300, and reroute the authorization message to validation mapping gateway 2020.

In element 1220, validation mapping gateway 2020 creates a risk score for the transaction based on information that is preferably encoded in the temporary payment card data and using information stored in the mapping gateway database. This risk score may take into account, for example, one or more of the following factors (alone or in combination with one another):
(a) the elapsed time since the temporary credential was issued;
(b) the difference between the geo location of the merchant and the geo location of the device 50 when the temporary credential was issued;
(c) the difference between the geo location of the merchant known to the risk assessment system and the geo location of the device when the temporary credential is redeemed;
(d) the date and time of redemption;
(e) the recency since last use of the temporary credential;
(f) the amount of the merchant authorization request;
(g) type of merchant;
(h) historical usage patterns of the user; and
(i) contemporaneous and dynamic security policies, including tracked behavior, and current facility access policy.
   For example, the age of the credential may be compared with the difference in geo location to provide a significant risk assessment. In particular, if the credential was issued less than an hour earlier but at a geo location hundreds of miles from the current merchant to which it is being presented for redemption, the transaction would be suspect. In this manner, the various parameters may be considered by the risk scoring engine to create a risk score. This risk score along with the legacy payment data may be passed to the issuer for an authorization decision as a second authorization message, step 1222. Issuer 310 may process the second Track 1/Track 2 data to determine whether to authorize the transaction. If authorized, Issuer 310 may respond to management back end 300 in element 1224 with an authorized message. Management back end 300 may map the second Track 1/Track 2 data back to the first Track 1/Track 2 data, and forward to the payment network system 1204 a second authorized message. In some embodiments, the Issuer may also receive information about the user's digital device signature, such that the Issuer may communicate directly with the end user via device 50 to request input of the CVV (see FIG. 9D). The issuer may use that information to further validate the transaction.

In element 1230, payment network system 1204 optionally may forward the second authorized message to the POS terminal 1202. In offline transactions, for example, the POS terminal will batch reconcile at end of day with the payment network system 1204. In response, the POS terminal will collect all the authorization messages as proof of liability transfer to the issuing bank. For online transactions, POS terminal 1202 optionally may wait to approve a transaction until the receipt of the second authorized message.

In this new method, the geo-location data would be captured at the time of authorization rather than (or in addition to) the time of issuance, by the portable device payment wallet. In the new method, the geo location data may also be encoded by the payment wallet into the data format (e.g. discretionary data fields of Track 1/Track 2 data format) that will be redeemed at the POS or access point. The back-end risk engines can then score the risk associated with redemption of a previously issued one-time token at the specific merchant or facility identified by the geolocation data. But in this new method, the token can be issued well in advance of use and it can be refreshed as policy requires, to minimize the threat of theft or misuse.

The dynamic credentials/payment tokens may also be limited in some embodiments to a “one time” use. They might be used repeatedly within a specified date or time range (e.g.) subject to velocity limits and other redemption policies. It is also contemplated that the dynamic credentials may be redeemable only at specific merchants or only within specific redemption limits (amount, date, time of day). We should be specific that this supports physical access applications (e.g. hotel door, campus building), not just payment. These tokens might also be issued well in advance of use.

The foregoing description and drawings merely explain and illustrate the invention and the invention is not limited thereto. While the specification is described in relation to certain implementation or embodiments, many details are set forth for the purpose of illustration. Thus, the foregoing merely illustrates the principles of the invention. For example, the invention may have other specific forms without departing from its spirit or essential characteristic. The described arrangements are illustrative and not restrictive. To those skilled in the art, the invention is susceptible to additional implementations or embodiments and certain of these details described in this application may be varied considerably without departing from the basic principles of the invention. It will thus be appreciated that those skilled in the art will be able to devise various arrangements which, although not explicitly described or shown herein, embody the principles of the invention and, thus, within its scope and spirit.

What is claimed is:

1. A system for issuing a dynamic temporary credential to a portable communication device for use in a transaction with an electronic control point, the portable communication device having a service that provides a current geo-location of the portable communication device, the system comprising:
means in a centralized computer for receiving the current geo-location of the portable communication device;
means for transmitting the dynamic temporary credential to the portable communication device from the centralized computer; and
means for scoring the risk of authorizing a transaction associated with the electronic control point using the dynamic temporary credential.

2. The system of claim 1 further comprising means for authenticating an end user of the portable communication device, wherein the dynamic temporary credential transmitting means does not function until the end user authenticating means has authenticated the end user.

3. The system of claim 2 further comprising a user database providing associations between the end user name and a passcode, wherein the authenticating means is operably associated with the user database and authenticates the end user by confirming the passcode.

4. The system of claim 3 wherein the portable communication device has a unique digital signature, the authenticating means further authenticates the end user by confirming the pairing the authenticated end user with the unique digital signature.

5. The system of claim 4 further comprising means for confirming the identity of the customer.

6. The system of claim 2 wherein the portable communication device has a unique digital signature, the authenticating means further authenticates the end user by confirming the pairing the authenticated end user with the unique digital signature.

7. The system of claim 1 further comprising a validation mapping gateway operably connected to one or more issuers, the system further comprising means associated with the validation mapping gateway to substitute the legacy payment data for the dynamic temporary credential in a payment transaction before sending the payment transaction along with the risk score to the issuer associated with the legacy payment data.

8. The system of claim 7 wherein the risk scoring means determines the distance between the geo-location of the portable communication device when the dynamic temporary credential was issued and at the time of the transaction.

9. The system of claim 7 wherein the risk scoring means determines risk dependent on consistency of the geo-location of the portable communication device at the time of the transaction and the geo-location of the merchant whose merchant id is included in the transaction authorization message.

10. The system of claim 7 wherein the risk scoring means determines increasing risk correlated to increasing time since issuance of the dynamic temporary credential.

11. The system of claim 7 wherein the risk scoring means determines consistency of the merchant type and/or merchant id with the expected merchant type and/or merchant id predicted by the management back end when dynamic temporary credential was issued.
